(19) United States
(12) Patent Application Publication
(10) Pub. No.: US 2012/0133159 A1
(43) Pub. Date: May 31, 2012

(54) DOOR HANDLE APPARATUS

(75) Inventors: Masashi TATEISHI, Nagoya-shi (JP); Eiji Mushiake, Chita-gun (JP); Takehiro Tabata, Kariya-shi (JP); Tatsuji Hasegawa, Kariya-shi (JP)

(73) Assignee: AISIN SEIKI KABUSHIKI KAISHA, Kariya-shi (JP)

(21) Appl. No.: 13/297,810

(22) Filed: Nov. 16, 2011

(30) Foreign Application Priority Data
Nov. 26, 2010 (JP) 2010-263634

(51) Int. Cl. E05B 3/00

(52) U.S. Cl. 292/336.3

(57) ABSTRACT

A door handle apparatus includes a first handle case including a holding portion defining a gap between the holding portion and an outer surface of an outer panel of a vehicle door, a second handle case attached to the first handle case, a conductive member provided at an outer surface of the second handle case, a lock detection electrode facing the conductive member and facing an inner surface of the second handle case for establishing a capacitive coupling between the lock detection electrode and the conductive member, the lock detection electrode detecting a door-lock command on the basis of a fluctuation of an electrostatic capacity generated in response to a contact or an approach of a vehicle user to the conductive member, and a decorating piece surrounding the conductive member, joined to the outer surface of the second handle case and defining a design surface of the door handle apparatus.

### CROSS REFERENCE TO RELATED APPLICATIONS

This application is based on and claims priority under 35 U.S.C. §119 to Japanese Patent Application 2010-263634, filed on Nov. 26, 2010, the entire content of which is incorporated herein by reference.

### TECHNICAL FIELD

This disclosure generally relates to a door handle apparatus.

### BACKGROUND DISCUSSION

Known door handle apparatuses are disclosed in Patent reference 1 (i.e., JP4079646B), Patent reference 2 (i.e., JP3502848B), Patent reference 3 (i.e., JP2009-30360A) and Patent reference 4 (i.e., JP2009-30358A). A so-called Smart Entry System (registered trademark) is mounted on the door handle apparatuses disclosed in the above patent references, in which, for example, the Smart Entry System recognizes that a vehicle user approaches a vehicle or that the vehicle user gets out of the vehicle, on the basis of a communication between a portable device carried by the vehicle user and a transmission device of the vehicle, while the Smart Entry System detects a door-lock command or a door-unlock command relative to a vehicle door of the use's vehicle in order to automatically execute locking and unlocking operations. A detection electrode for detecting the door-lock command and a detection electrode for detecting the door-unlock command are arranged inside a handle case that constitutes an outer shape of the door handle. The detection electrodes are arranged so as to correspond to points at which the door lock/unlock commands are inputted by the vehicle user in accordance with user's intention of locking/unlocking the vehicle door, respectively. For example, a lock detection electrode for detecting the door-lock command is arranged facing an inner surface of an outer portion, which defines a design surface of the handle case (the door handle apparatus), of the handle case (the door handle apparatus).

In the door handle apparatuses disclosed in the above patent references, it is suggested that a decoration is applied to the outer portion of the handle case in order to improve an aesthetic appearance of the door handle apparatuses. In this case, a decorating piece employing, instead of a known chrome coating, an indium film, which is not subjected to a coupling reaction with, for example, the lock detection electrode and which does not block an output of an antenna, is provided at the outer portion of the handle case to cover the outer portion of the handle case. Accordingly, a distance between the vehicle user operating the door handle and the lock detection electrode increases by a thickness of the decorating piece, which may decrease a detection sensitivity of the lock detection electrode. On the other hand, in case that the distance between the vehicle user operating the door handle and the lock detection electrode is set within a certain range in order to restrict reduction in the detection sensitivity of the lock detection electrode, a position at which the decorating piece may be arranged (that is, an area that is allowed to be decorated) is limited.

A need thus exists for a door handle apparatus which is not susceptible to the drawback mentioned above.

### SUMMARY

According to an aspect of this disclosure, a door handle apparatus adapted to be mounted on an outer panel of a vehicle door, includes a first handle case including a holding portion defining a gap between the holding portion and an outer surface of the outer panel of the vehicle door, a second handle case attached to the first handle case in a manner that the second handle case covers the first handle case, a conductive member provided at an outer surface of the second handle case, a lock detection electrode arranged facing the conductive member and facing an inner surface of the second handle case for establishing a capacitive coupling between the lock detection electrode and the conductive member, the lock detection electrode detecting a door-lock command on the basis of a fluctuation of an electrostatic capacity generated in response to a contact or an approach of a vehicle user relative to the conductive member, and a decorating piece surrounding the conductive member, joined to the outer surface of the second handle case and defining a design surface of the door handle apparatus.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a longitudinal sectional-view illustrating a first embodiment disclosed here;

FIG. 2 is an exploded perspective view of the first embodiment;

FIG. 3 is a cross sectional-view taken along line III-III in FIG. 1;

FIG. 4 is a block diagram mainly illustrating a system configuration of a door locking system according to the first embodiment;

FIG. 5 is a longitudinal sectional-view illustrating a second embodiment disclosed here;

FIG. 6 is an exploded perspective view of the second embodiment;

FIG. 7 is a cross sectional-view taken along line VII-VII in FIG. 5;

FIG. 8 is a longitudinal sectional-view illustrating a third embodiment disclosed here;

FIG. 9 is an exploded perspective view of the third embodiment;

FIG. 10 is a cross sectional-view taken along line X-X in FIG. 8;

FIG. 11 is an exploded perspective view of a fourth embodiment; and

FIG. 12 is a cross sectional-view illustrating the fourth embodiment.

### DETAILED DESCRIPTION

A first embodiment of a door handle apparatus, on which a Smart Entry System (registered trademark) is mounted, will be described hereinafter. As used herein, the terms “outer”, “inner”, “front”, “rear”, “upper”, “lower” and derivatives thereof are based on directions relative to a vehicle on which the door handle apparatus is configured to be mounted.

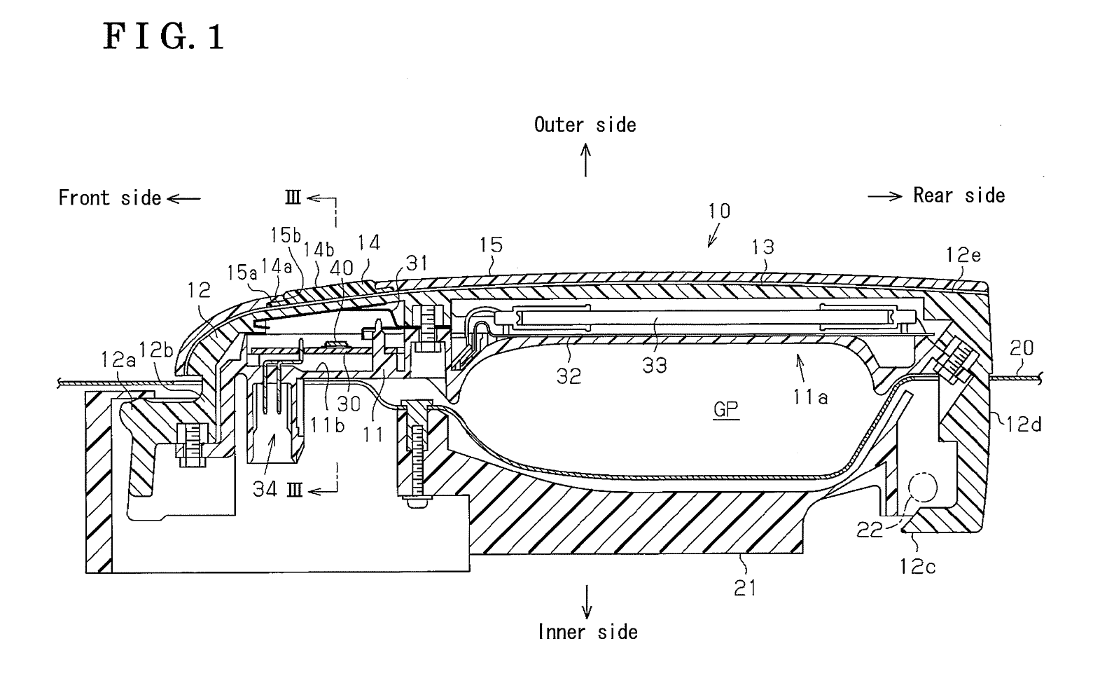

As illustrated in FIG. 1, a door handle 10 includes a first handle case 11 and a second handle case 12. The first handle case 11, which is formed in a shape of a long lid and constitutes an inner portion of the door handle 10, is provided to extend in the front/rear direction of the vehicle. The second handle case 12, which is formed into a shape of a long box and constitutes an outer portion of the door handle 10, is provided to cover the first handle case 11. Each of the first and second handle cases 11 and 12 is made of a resin material having a high rigidity. The first and second handle cases 11 and 12 are fastened to each other with, for example, a screw.

The first handle case 11 includes a holding portion 11a arranged to be distant away from an outer surface of an outer panel 20 of a vehicle door by a gap GP. A substrate accommodating portion 11b having a shape of a box opening outwardly is formed at a front portion of the holding portion 11a. A circuit substrate 30, on which electronic components are mounted, is accommodated in the substrate accommodating portion 11b. A lock detection electrode 31 of an electrostatic capacity sensor 41 is electrically connected to the circuit substrate 30. On the basis of a fluctuation of the electrostatic capacity, the electrostatic capacity sensor 41 detects that a door-lock command of the vehicle, that is, the command for locking the vehicle door, is given. The lock detection electrode 31 is arranged so as to face an inner surface of an outer wall of the second handle case 12 and so as to face the circuit substrate 30. The lock detection electrode 31 is closely attached to the inner surface of the outer wall of the second handle case 12.

The first handle case 11 includes an unlock detection electrode 32 of an electrostatic capacity sensor 42 detecting, on the basis of the fluctuation of the electrostatic capacity, that a door-unlock command, that is, the command for unlocking the vehicle door is given. The unlock detection electrode 32 is provided at an inner surface of the holding portion 11a and is electrically connected to the circuit substrate 30. Further, an antenna 33 is provided in a vicinity of the inner surface of the holding portion 11a of the first handle case 11. Information signals are transmitted between a portable device carried by a user and a door control portion 50 via the antenna 33 in order to authenticate the user, for example. The antenna 33 is electrically connected to the circuit substrate 30. A sensor IC 40 to which the electrostatic capacity sensors 41, 42 are incorporated and which is mounted on the circuit substrate 30, and the antenna 33 are supplied with electricity via a connector 34 provided at a back surface of the circuit substrate 30, while information signals outputted by the sensor IC 40 are inputted into the door control portion 50 via the connector 34. An antenna cover assembly is constituted by the first handle case 11, and, for example, the lock detection electrode 31, the unlock detection electrode 32 and the antenna 33 which are provided at the first handle case 11.

The second handle case 12 is supported by a supporting member 21 provided in an inside of the outer panel 20. The supporting member 21 is made of a resin material and formed in a shape of a frame. A rotational-portion extending portion 12b is provided at one longitudinal end portion of the second handle case 12, that is, the longitudinal end portion located forward to the substrate accommodating portion 11b, by penetrating through the outer panel 20 of the vehicle door. A rotational portion 12a which is rotatably supported by the supporting member 21 extends from the rotational-portion extending portion 12b. An operational-portion extending portion 12d is provided at the other longitudinal end portion of the second handle case 12, that is, the operational-portion extending portion 12d is positioned opposite to the rotational-portion extending portion 12b relative to the holding portion 11a. The operational-portion extending portion 12d extends so as to penetrate through the outer panel 20 of the vehicle door. An operational portion 12c for operating a lever 22 of a door opening and closing mechanism, which is provided at an inner side of the outer panel 20, extends from the operational-portion extending portion 12d. Accordingly, when the vehicle user holds the holding portion 11a and pulls the door handle 10, the door handle 10 is pivoted in a direction in which the operational-portion extending portion 12d is pulled while the rotational-portion extending portion 12b serving as a base end of the pivoting. At this time, unless the vehicle door is in a locked state, the lever 22 is operated by means of the operational portion 12c, and thus the vehicle door is opened. The circuit substrate 30 provided at the first handle case 11 (that is, accommodated in the substrate accommodating portion 11b) is arranged between the holding portion 11a and the rotational-portion extending portion 12b in the front/rear direction.

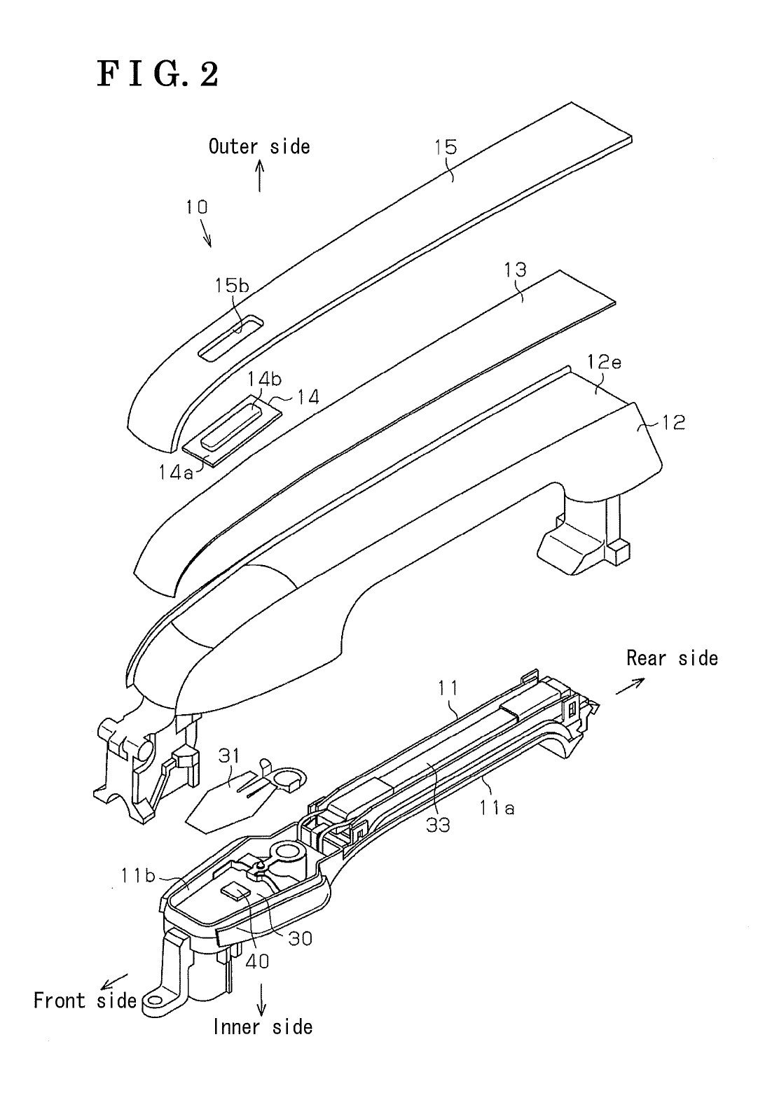

As illustrated in FIG. 2, an attachment groove 12e having a substantially U shape is formed at an outer surface of the outer wall, which faces the outside of the vehicle, of the second handle case 12 so as to extend along a full length of the second handle case 12 in a longitudinal direction thereof. A double faced adhesive tape 13 made of, for example, acrylic foam and having a band shape is adhered to the attachment groove 12e along the full length of the second handle case 12 in the longitudinal direction thereof. A conductive piece 14 made of, for example, metal or conductive resin and serving as a conductive member is fixedly adhered to a front end portion of the double faced adhesive tape 13 (the attachment groove 12e) at a portion facing the lock detection electrode 31 via the second handle case 12. The conductive piece 14 is provided to parallelly face the lock detection electrode 31, that is, an inner surface of the conductive piece 14 and an outer surface of the lock detection electrode 31 are parallel to each other, via the second handle case 12 and the double faced adhesive tape 13. Thus, a capacitive coupling is established between the conductive piece 14 and the lock detection electrode 31, that is, the conductive piece 14 and the lock detection electrode 31 is electrostatic-capacitively coupled, so that a detecting performance for detecting the door-lock command is assured. A base portion 14a, which has a rectangular shape whose lateral width is smaller than a lateral width of the attachment groove 12e, is formed at the conductive piece 14. Further, a lock operational portion 14b, which has a rectangular bar shape protruding outwardly from a substantially middle portion of the base portion 14a, is formed at the conductive piece 14.

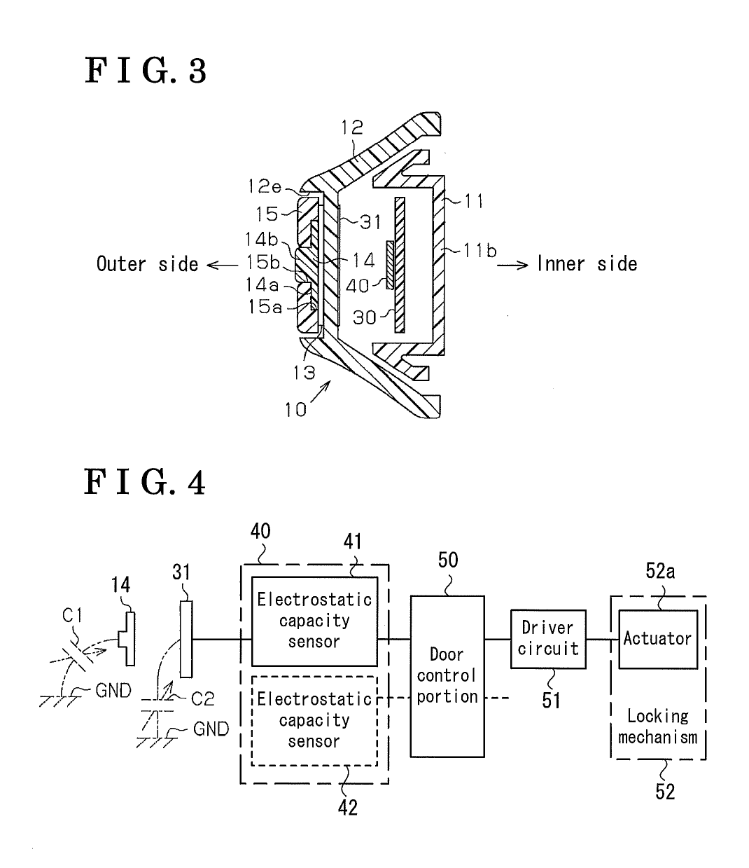

A decorating piece 15 having a band shape is fixedly adhered to the double faced adhesive tape 13, at which the conductive piece 14 is provided, along a full length of the double faced adhesive tape 13 in a longitudinal direction thereof. As illustrated in FIG. 3, an engaging recessed portion 15a, which has a rectangular shape and into which the base portion 14a fits, is formed at the decorating piece 15. Further, an engaging hole 15b having a long hole shape is formed at the decorating piece 15 by opening a substantially middle portion of the engaging recessed portion 15a. The decorating piece 15, which is adhered to the double faced adhesive tape 13, engages with the base portion 14a at the engaging recessed portion 15a and engages with the lock operational portion 14b at the engaging hole 15b, thereby supporting the conductive piece 14. A handle case assembly is constituted by the second handle case 12, and, for example, the conductive piece 14 and the decorating piece 15 which are provided at the second handle case 12.

The decorating piece 15, which surrounds the conductive piece 14, decorates a design surface (i.e., an aesthetically pleasing surface) of the door handle 10. The decorating piece 15 includes a body portion made of, for example, a resin material and formed in the band shape, and an indium film is provided at an outer surface of the body portion. The indium film made of metal is used because, unlike a known chrome coating, the indium film will not be subjected to a coupling reaction, for example, with the lock detection electrode 31 and does not block an output of the antennal 30. The lock operational portion 14b, which faces the lock detection electrode 31, is exposed outwardly from the outer surface of the body portion of the decorating piece 15 by penetrating through the engaging hole 15b, thereby serving as an operational point indicating mark which indicates a sensing portion of the lock detection electrode 31, that is, the operational point indicating mark which indicates a point at which the door-lock command is to be inputted. The lock operational portion 14b is set to slightly protrude outwardly from the outer surface of the decorating piece 15 located adjacent to the lock operational portion 14b. In other words, a step is provided between a surface of the decorating piece 15 and a surface of the conductive piece 14 (the lock operational portion 14b).

Next, an electric configuration related to a door locking system of the first embodiment will be described. As illustrated in FIG. 4, the lock detection electrode 31 is electrically connected to the electrostatic capacity sensor 41 that is incorporated in the sensor IC 40. The electrostatic capacity sensor 41 is electrically connected to the door control portion 50 configured mainly by, for example, a micro controller and electrically connected to a driver circuit 51. The driver circuit 51 is electrically connected to an actuator 52a for locking the vehicle door, which is provided at a locking mechanism 52.

Next, an operation (a detection principle and an outline of the operation) of the first embodiment will be described. As illustrated in FIG. 4, an electrostatic capacity between a ground GND and the conductive piece 14 is referred to as an electrostatic capacity C1. As the vehicle user touches or approaches the conductive piece 14, the electrostatic capacity C1 fluctuates. At this time, an electrostatic capacity of the lock detection electrode 31 fluctuates significantly in response to the fluctuation in the electrostatic capacity C1, which is generated when the vehicle user touches or approaches the conductive piece 14, because the capacitive coupling is established between the conductive piece 14 and the lock detection electrode 31.

On the other hand, according to a known door handle which does not include the conductive piece 14 and in which the electrostatic capacity between the ground GND and the lock detection electrode 31 is referred to as an electrostatic capacity C2, as the vehicle user touches or approaches the door handle, the electrostatic capacity C2 fluctuates. In this case, however, the lock detection electrode 31 is located away from the vehicle user by a thickness of the decorating piece 15, and thus the fluctuation in the electrostatic capacity of the lock detection electrode 31 is relatively small.

In other words, the fluctuation in the electrostatic capacity of the lock detection electrode 31, which is generated when the vehicle user touches or approaches the conductive piece 14, is larger in the first embodiment than in the known door handle because the conductive piece 14 is located closer to the vehicle user in the first embodiment.

When, for example, a hand of the vehicle user approaches or touches the lock operational portion 14b (a portion facing the lock detection electrode 31) of the conductive piece 14, the electrostatic capacity of the lock detection electrode 31, which is electrostatic-capacitively coupled to the conductive piece 14, is transferred into the electrostatic capacity sensor 41. On the basis of the electrostatic capacity of the lock detection electrode 31, the electrostatic capacity sensor 41 detects that the door-lock command has been given. Thus, when an issuance of the door-lock command is detected via the electrostatic capacity sensor 41, the door control portion 50 determines, on the basis of a detection signal of the electrostatic capacity sensor 41, that the door-lock command is given by the vehicle user. Via the driver circuit 51, the door control portion 50 drives the actuator 52a of the locking mechanism 52, which is the actuator for locking the vehicle door, and thus the vehicle door is locked. The detection principle and the outline of the operation as described above apply also to a door unlocking system for unlocking the vehicle door in cooperation with the unlock detection electrode 32 and the electrostatic capacity sensor 42 which is incorporated to the sensor IC 40.

As described above, the following effects and advantages are attained according to the first embodiment. (1) According to the first embodiment, the decorating piece 15 is joined to the outer surface of the second handle case 12, thereby enhancing an esthetic appearance of the second handle case 12, and eventually, an esthetic appearance of the door handle apparatus. In this case, a distance between the lock detection electrode 31 facing an inner surface of the second handle case 12 and the vehicle user is increased by the thickness of the decorating piece 15, however, the conductive piece 14, which is surrounded by the decorating piece 15, is electrostatic-capacitively coupled to the lock detection electrode 31. Thus, the fluctuation in the electrostatic capacity of the lock detection electrode 31, which is caused when the vehicle user touches or approaches the conductive piece 14, may be assured appropriately, thereby restricting decrease in a detection sensitivity of the lock detection electrode 31 relative to the door-lock command.

(2) According to the first embodiment, the conductive piece 14 penetrates through the decorating piece 15 and is exposed outwardly from the outer surface of the decorating piece 15, which allows the vehicle user to directly touch the conductive piece 14 (the lock operational portion 14b). This improves the detection sensitivity, relative to the door-lock command, of the lock detection electrode 31 that has the capacitive coupling between the conductive piece 14. Further, the vehicle user may visually recognize the conductive piece 14 exposed on the surface of the decorating piece 15 and operate the door handle apparatus by, for example, touching the conductive piece 14 in order to give the door-lock command. Thus, an operability of the door handle apparatus is improved.

(3) According to the first embodiment, the step is provided between the surface of the decorating piece 15 and the surface of the conductive piece 14. Thus, even under poor visibility, for example, during nighttime, the vehicle user may feel the step by tracing the surface of the decorating piece 15, and may operate the door handle apparatus by, for example, touching the conductive piece 14 in order to give the door-lock command.

(4) According to the first embodiment, the lock operational portion 14b, which is exposed outwardly, may serve as the operational point indicating mark which indicates the sensing portion of the lock detection electrode 31. (5) According to the first embodiment, the double faced adhesive tape 13, to which the conductive piece 14 is fixed, may isolate water, which is accumulated in a parting portion of the second handle case 12 (the attachment groove 12e) and the decorating piece 15 in the longitudinal direction of the second handle case 12, from the conductive piece 14, and thus, a water-stop function is obtained.

(6) According to the first embodiment, the door handle 10 (the second handle case 12) may be decorated easily, unconstrained by an arrangement, that is, for example, a location and an orientation, of the lock detection electrode 31 (i.e., the sensing portion), while restricting deterioration of the detecting performance. Thus, a degree of freedom, from an aesthetic viewpoint, of the door handle 10 is improved.

(7) According to the first embodiment, the antenna cover assembly is independent from the design of the handle case assembly, therefore, for example, a height of the design surface of the handle case assembly when viewed in FIG. 1 (a thickness of the door handle) may be changed without modifying a structure of the antenna cover assembly. Consequently, the antenna cover assembly may be standardized easily so as to be applied to a number of vehicle types.

(8) According to the first embodiment, a housing (a case) of the door handle 10 is configured by a splitable body which may be split into two portions including the first handle case 11 and the second handle case 12 so that the door handle 10 may be designed and manufactured more freely and more easily.

(9) According to the first embodiment, the conductive piece 14 and the lock detection electrode 31 are fixedly provided so that positions of the conductive piece 14 and the lock detection electrode 31 do not vary from time to time. Further, there are substantially no variations in a way in which the vehicle user touches the lock operational portion 14b of the conductive piece 14. This is because in case that the vehicle user's finger touches the lock operational portion 14b of the conductive piece 14, an equivalent effect may be obtained to an effect obtained in case that the vehicle user's finger touches the sensing portion of the lock detection electrode 31 with a contact area contacting the lock detection electrode 31, which corresponds to a contact area of the base portion 14a that faces the lock detection electrode 31. Consequently, the variations in the positions of the conductive piece 14 and the lock detection electrode 31, and the variations in the way in which the vehicle user touches the lock operational portion 14b are reduced, thereby reducing variations in the detection sensitivity of the lock detection electrode 31. In other words, a detection sensitivity attained when the vehicle user touches the lock operational portion 14b is equivalent to a detection sensitivity that would be attained when the vehicle user touches the sensing portion at which the detection sensitivity of the lock detection electrode 31 is at the largest (that is, a middle portion of the lock detection electrode 31). Specifically, the detection sensitivity of the lock detection electrode 31 increases as an area of the conductive piece 14, that is, the area of a portion of the conductive piece 14, which faces the lock detection electrode 31, increases, consequently, the variations in the detection sensitivity of the lock detection electrode 31 is even more reduced.

A second embodiment of the door handle apparatus will be described hereinafter. In the second embodiment, the decorating piece is provided to cover a conductive plate, which differs from the structure in the first embodiment. Accordingly, detailed explanation about the identical configuration to that of the first embodiment will be omitted.

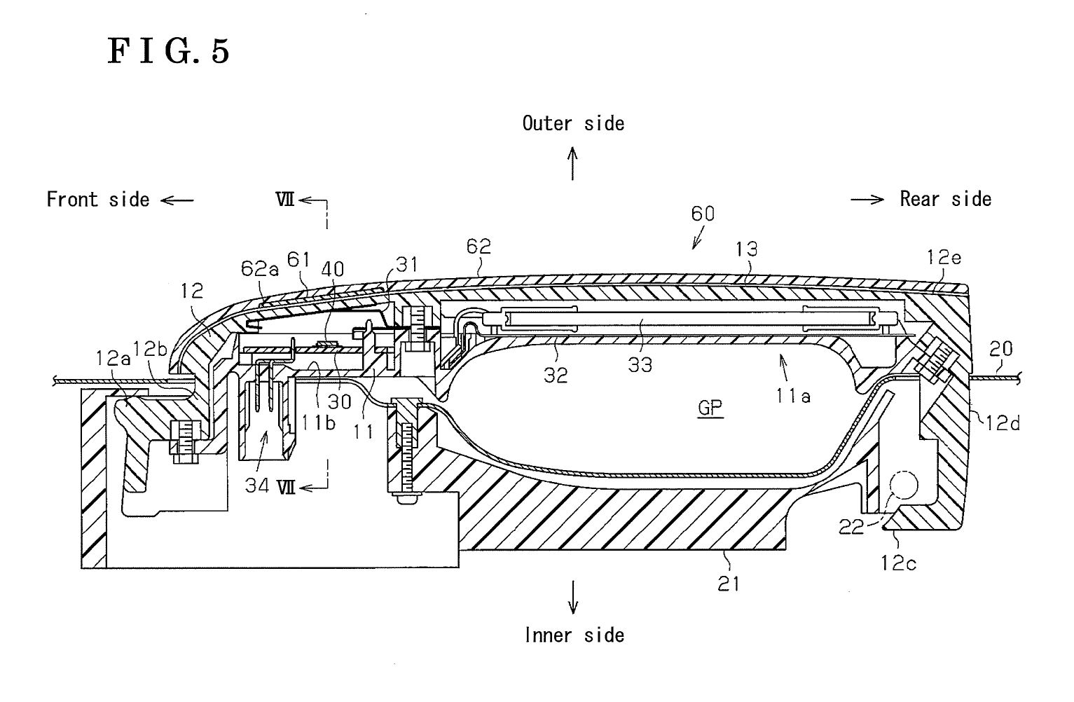

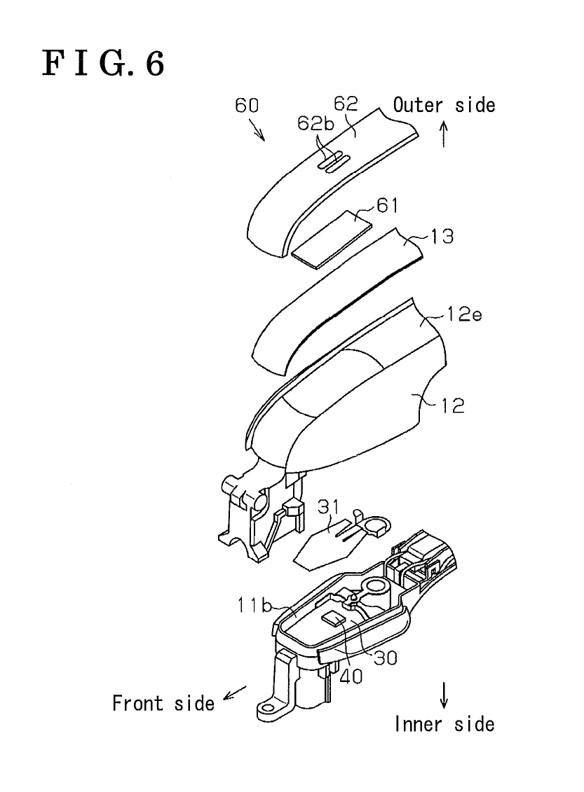

As illustrated in FIGS. 5 and 6, according to a door handle 60 of the second embodiment, a conductive plate 61 made of, for example, metal or conductive resin and serving as the conductive member is fixedly adhered to the front end portion of the double faced adhesive tape 13 (the attachment groove 12e) at the portion that faces the lock detection electrode 31 via the second handle case 12. The conductive plate 61 is provided to parallelly face the lock detection electrode 31, that is, an inner surface of the conductive plate 61 and the outer surface of the lock detection electrode 31 are parallel to each other, via the second handle case 12 and the double faced adhesive tape 13. Thus, the capacitive coupling is established between the conductive plate 61 and the lock detection electrode 31 so that the conductive plate 61 assures a detecting performance for detecting the door-lock command. The conductive plate 61 is formed in a rectangular plate whose lateral width is smaller than the lateral width of the attachment groove 12e.

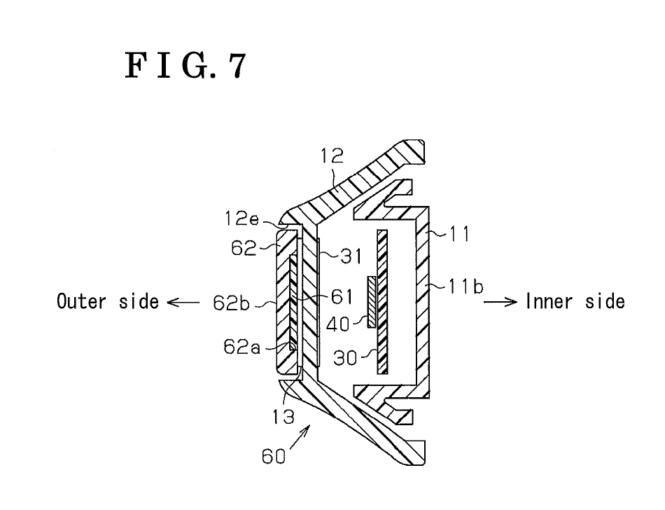

A decorating piece 62 having a band shape is fixedly adhered to the double faced adhesive tape 13 at which the conductive plate 61 is provided, along the full length of the double faced adhesive tape 13 in the longitudinal direction thereof. As illustrated in FIG. 7, an engaging recessed portion 62a, which has a rectangular shape and into which the conductive plate 61 fits, is formed at the decorating piece 62. The decorating piece 62, which is adhered to the double faced adhesive tape 13, engages with the conductive plate 61 at the engaging recessed portion 62a, thereby supporting the conductive plate 61. Thus, an outer surface of the conductive plate 61 is covered with a surface of the engaging recessed portion 62a, more specifically, covered with the surface that faces the conductive plate 61. The decorating piece 62, which surrounds the conductive plate 61 so as to hide the conductive plate 61 inside the decorating piece 62, decorates a design surface (i.e., the aesthetically pleasing surface) of the door handle 60. The decorating piece 62 includes a body portion made of, for example, a resin material and is formed in a band shape, and the indium film is provided at an outer surface of the body portion.

An operational point indicating mark 62b having a stripe shape is formed in a recessed manner at a front end portion of the decorating piece 62 at an outer surface thereof facing the lock detection electrode 31. The operational point indicating mark 62b indicates the sensing portion of the lock detection electrode 31, that is, the point at which the door-lock command is to be inputted.

Next, an operation of the second embodiment will be described. When the hand of the vehicle user approaches or touches the operational point indicating mark 62b (a portion facing the conductive plate 61 and facing the lock detection electrode 31) of the decorating piece 62, the electrostatic capacity of the lock detection electrode 31, which is electrostatic-capacitively coupled to the conductive plate 61, is transferred into the electrostatic capacity sensor 41. On the basis of the electrostatic capacity of the lock detection electrode 31, the electrostatic capacity sensor 41 detects that the door-lock command has been given. Thus, when the issuance of the door-lock command is detected via the electrostatic capacity sensor 41, the vehicle door is locked in a manner similar as described in the first embodiment.

According to the second embodiment described above, the following effects and advantages are attained in addition to the effects and advantages (1) and (6) through (8) which are attained according to the first embodiment. (10) According to the second embodiment, the conductive plate 61 is not exposed on a surface of the decorating piece 62, thereby further enhancing the esthetic appearance. Further, the conductive plate 61 is covered with the decorating piece 62, and thus it may be restricted that the lock detection electrode 31 erroneously detects the door-lock command because, for example, the conductive plate 61 becomes wet.

(11) According to the second embodiment, operational point indicating mark 62b is formed at the decorating piece 62 so as to correspond to the arrangement of the conductive plate 61. Thus, the vehicle user may recognize the arrangement, that is, for example, the location and the orientation, of the conductive plate 61 by identifying the operational point indicating mark 62b, and may operate the door handle apparatus by, for example, touching the decorating piece 62 with consideration for the arrangement of the conductive plate 61 in order to give the door-lock command. Thus, the operability of the door handle apparatus is improved. Especially, the decorating piece 62 is formed to include the recess and protrusion which serve as the operational point indicating mark 62b, and thus even under the poor visibility, for example, during nighttime, the vehicle user may feel the operational point indicating mark 62b by tracing the surface of the decorating piece 62. Thus, the vehicle user may operate the door handle apparatus by, for example, touching the decorating piece 62, with consideration for the arrangement of the conductive plate 61 (and the lock detection electrode 31) in order to give the door-lock command.

A third embodiment of the door handle apparatus will be described hereinafter. In the third embodiment, the arrangements of, for example, the lock detection electrode and the conductive piece facing the lock detection electrode are changed from the first and second embodiments. Accordingly, detailed explanation about the identical configuration to those of the first and second embodiments will be omitted.

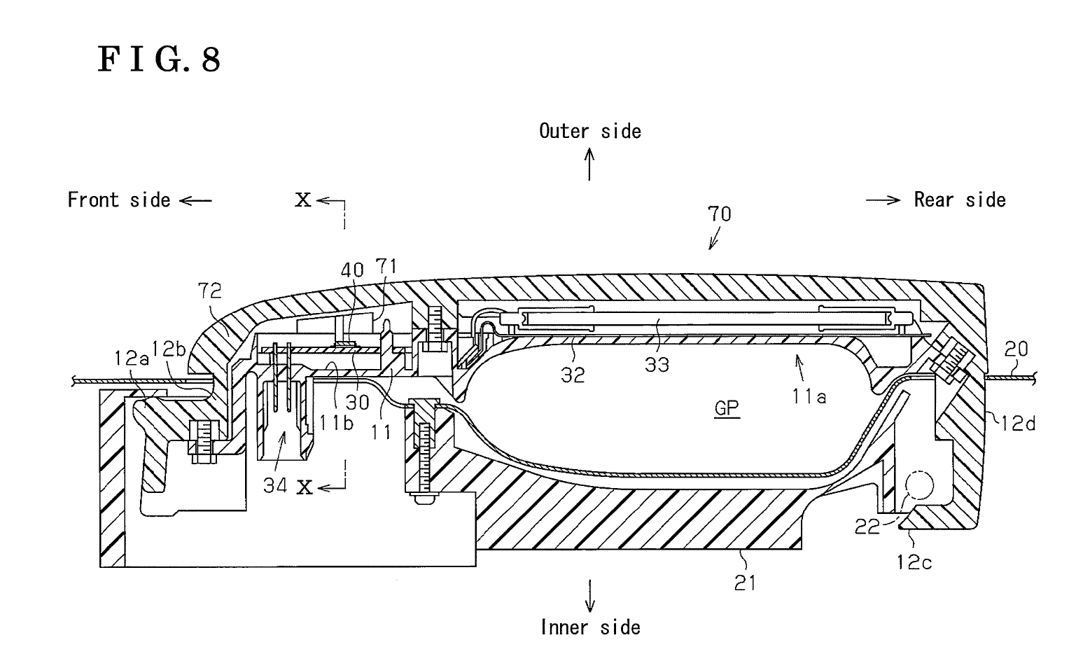

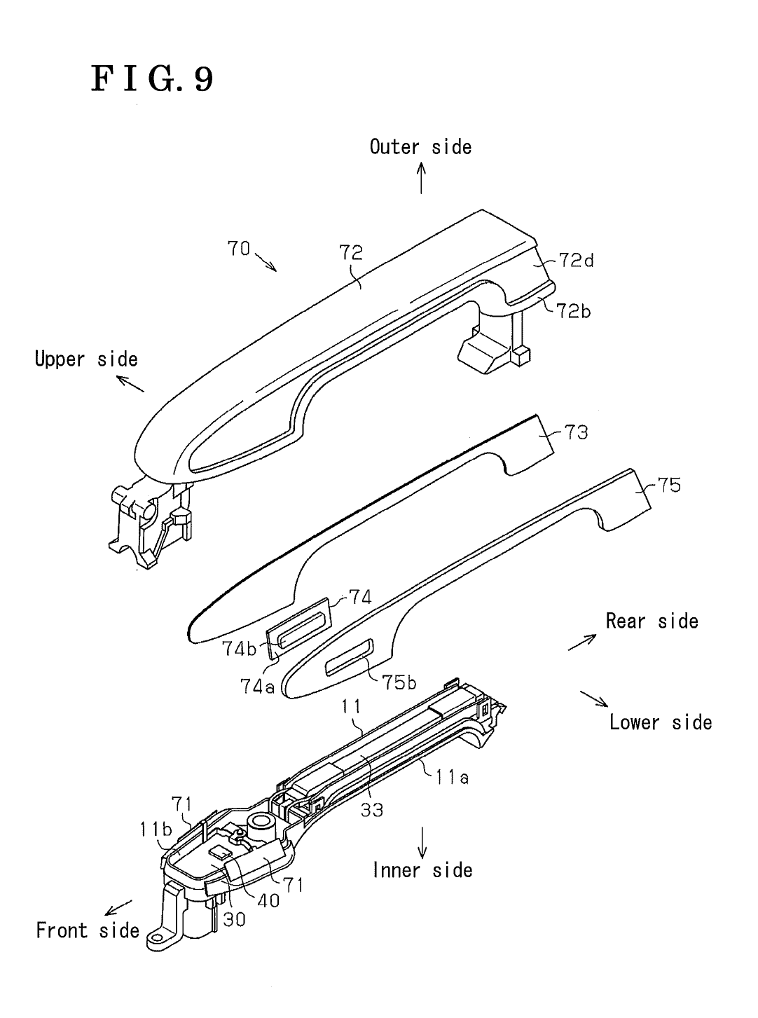

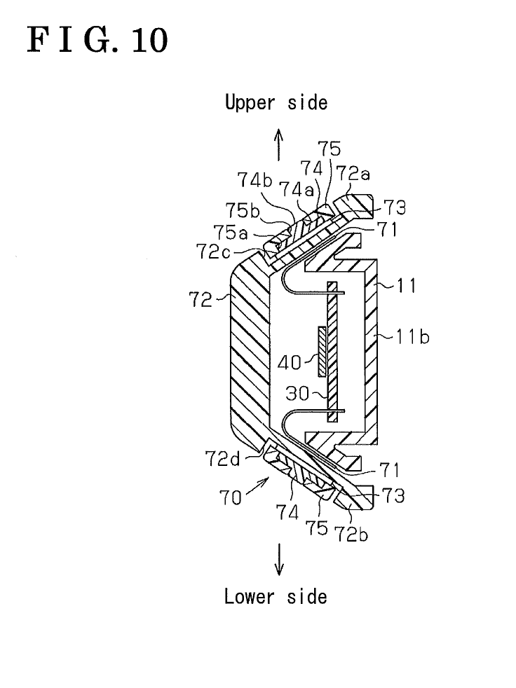

As illustrated in FIGS. 8 and 9, according to a door handle 70 of the third embodiment, a pair of lock detection electrodes 71, 71 of the electrostatic capacity sensor 41 is mounted on the circuit substrate 30 provided at the first handle case 11. The electrostatic capacity sensor 41 detects, on the basis of the fluctuation of the electrostatic capacity, that the door-lock command is given. The pair of lock detection electrodes 71, 71 is provided in a vicinity of an inner surface of a second handle case 72, more specifically, at an inner surface of an upper wall portion 72a of the second handle case 72 and at an inner surface of a lower wall portion 72b of the second handle case 72, respectively so as to face each other (refer to FIG. 10). The second handle case 72, which constitutes an outer portion of the door handle 70, is made of a resin material having a high rigidity and is formed in a shape of a long box.

As illustrated in FIG. 10, the second handle case 72 includes an attachment recessed portion 72c formed in a substantially arch shape at an outer surface of the upper wall portion 72a and an attachment recessed portion 72d formed in the substantially arch shape at an outer surface of the lower wall portion 72b, the attachment recessed portions 72c, 72d extend along a full length of the second handle case 72. A double faced adhesive tape 73 which is made of, for example, acrylic foam and which is formed in a substantially arch shape so as to correspond to outer contours of the attachment recessed portions 72c, 72d is adhered to each of the attachment recessed portions 72c, 72d. A conductive piece 74 made of, for example, metal or conductive resin and serving as the conductive member is fixedly adhered to a front end portion of each double faced adhesive tape 73 (the attachment recessed portions 72c, 72d), at a portion facing the corresponding lock detection electrode 71 via the second handle case 72. The conductive piece 74 is provided to parallelly face the lock detection electrode 71 via the second handle case 72 and the double faced adhesive tape 73. Thus, the capacitive coupling is established between each conductive piece 74 and the corresponding lock detection electrode 71 so that the detecting performance for detecting the door-lock command is assured. A base portion 74a, which has a rectangular shape whose lateral width is smaller than a lateral width of each of the attachment recessed portions 72c, 72d, is formed at each conductive piece 74. Further, a lock operational portion 74b, which has a rectangular bar shape protruding outwardly from a substantially middle portion of the base portion 74a, is formed at the conductive piece 74.

A decorating piece 75 having a substantially arch shape that corresponds to the outer contours of the attachment recessed portions 72c, 72d is fixedly adhered to each double faced adhesive tape 73 at which the conductive piece 74 is provided. An engaging recessed portion 75a, which has a rectangular shape and into which the base portion 74a fits, is formed at each decorating piece 75. Further, an engaging hole 75b having a long hole shape is formed at each decorating piece 75 by opening a substantially middle portion of the engaging recessed portion 75a. The decorating piece 75, which is adhered to each double faced adhesive tape 73, engages with the base portion 74a at the engaging recessed portion 75a and engages with the lock operational portion 74b at the engaging hole 75b, thereby supporting the conductive piece 74.

The decorating piece 75, which surrounds the conductive piece 74, decorates a design surface (i.e., the aesthetically pleasing surface) of the door handle 70. The decorating piece 75 includes a body portion made of a resin material and is formed into the substantially arch shape, and the indium film is provided at an outer surface of the body portion. The lock operational portion 74b is exposed outwardly from the outer surface of the body portion of the decorating piece 75 by penetrating through the engaging hole 75b, thereby serving as the operational point indicating mark which indicates a sensing portion of the lock detection electrode 71, that is, the operation point indicating mark which indicates a point at which the door-lock command is to be inputted. The lock operational portion 74b is set to slightly protrude outwardly from the outer surface of the decorating piece 75 located adjacent to the lock operational portion 74b. In other words, the step is provided between a surface of the decorating piece 75 and a surface of the conductive piece 74 (the lock operational portion 74b).

As described above, according to the third embodiment, the effects and advantages similar to those attained in the first embodiment will be attained. A fourth embodiment of the door handle apparatus will be described hereinafter. In the fourth embodiment, the decorating piece is provided to cover a conductive plate, which differs from the structure in the third embodiment. Accordingly, detailed explanation about the identical configuration to that of the third embodiment will be omitted.

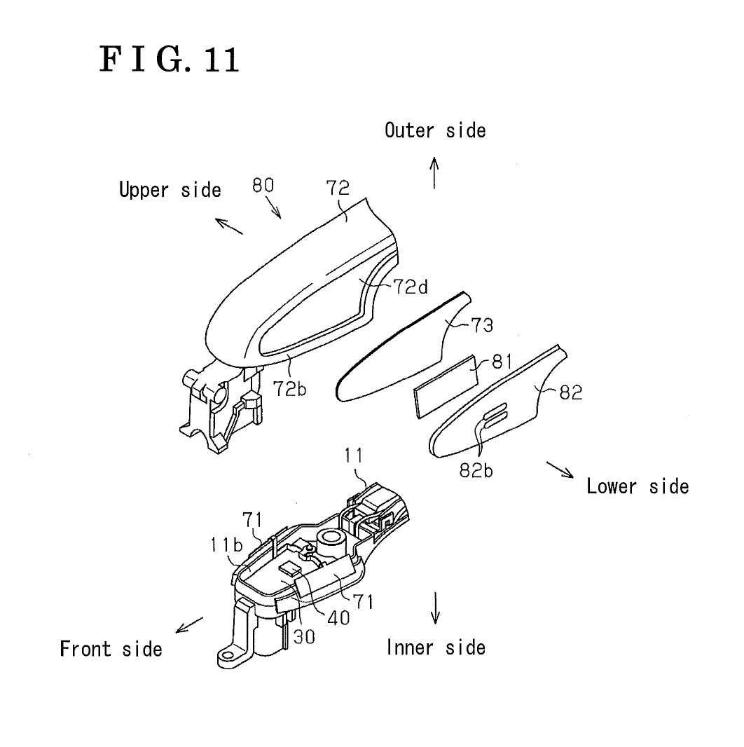

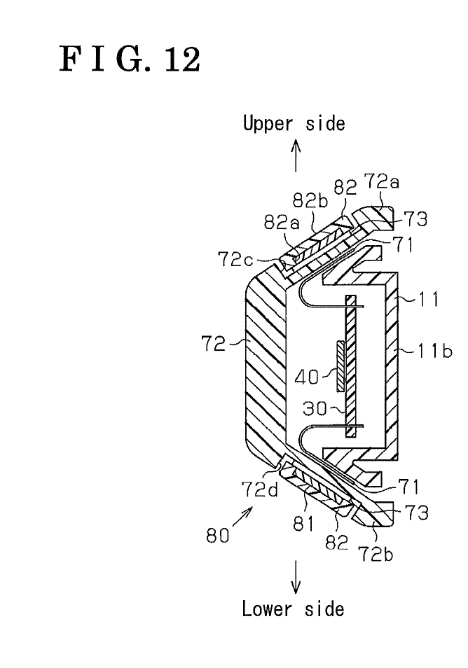

As illustrated in FIGS. 11 and 12, according to a door handle 80 of the fourth embodiment, a conductive plate 81 made of, for example, metal or conductive resin and serving as the conductive member is fixedly adhered to the front end portion of each double faced adhesive tape 73 (the attachment recessed portions 72c, 72d) at the portion that faces the corresponding lock detection electrode 71 via the second handle case 72. The conductive plate 81 is provided to parallelly face the lock detection electrode 71, via the second handle case 72 and the double faced adhesive tape 73. Thus, the capacitive coupling is established between each conductive plate 81 and the corresponding lock detection electrode 71 so that the detecting performance for detecting the door-lock command is assured. The conductive plate 81 is formed in a rectangular plate whose lateral width is smaller than the lateral width of each of the attachment recessed portions 72c, 72d.

A decorating piece 82 having a substantially arch shape that corresponds to the outer contours of the attachment recessed portions 72c, 72d is fixedly adhered to each double faced adhesive tape 73 at which the conductive plate 81 is provided. An engaging recessed portion 82a, which has a rectangular shape and in which the conductive plate 81 fits, is formed at each decorating piece 82. The decorating piece 82, which is adhered to the double faced adhesive tape 73, engages with the conductive plate 81 at the engaging recessed portion 82a, thereby supporting the conductive plate 81. Thus, an outer surface of the conductive plate 81 (that is, for example, the surface of the conductive plate 81 which faces a direction of an arrow indicated with “lower side” in FIG. 11), is covered with a surface of the engaging recessed portion 82a, more specifically, covered with the surface that faces the conductive plate 81. The decorating piece 82, which surrounds the conductive plate 81 so as to hide the conductive plate 81 inside the decorating piece 82, decorates a design surface (i.e., the aesthetically pleasing surface) of the door handle 80. The decorating piece 82 includes a body portion made of, for example, a resin material and is formed in the substantially arch shape, and the indium film is provided at an outer surface of the body portion.

An operational point indicating mark 82b having a stripe shape is formed in a recessed manner at a front end portion of the decorating piece 82 at an outer surface thereof facing the lock detection electrode 71 (that is, for example, the surface of the decorating piece 82 which faces the direction of the arrow indicated with “lower side” in FIG. 11). The operational point indicating mark 82b indicates the sensing portion of the lock detection electrode 71, that is, the point at which the door-lock command is to be inputted.

As described above, according to the fourth embodiment, the effects and advantages similar to those attained in the second embodiment will be attained. The first to fourth embodiments may be changed or modified as follows.

In the first and third embodiment, the lock operational portion 14b, 74b of the conductive piece 14, 74 may be slightly recessed inwardly from the outer surface of the decorating piece 15, 75 located adjacent to the lock operational portion 14b, 74b, respectively. The step between the surface of the decorating piece 15, 75 and the surface of the conductive piece 14, 74 (the lock operational portion 14b, 74b) may not necessarily be provided.

In the second and fourth embodiment, the operational point indicating mark 62b, 82b may be provided by means of printing, a two-color-resin-molding method or other methods. In the third and fourth embodiment, the decorating piece 75, 82 may be joined to either one of the upper wall portion 72a and the lower wall portion 72b of the second handle case 72. In this case, it is more desirable that the decorating piece 75, 82 is joined to the upper wall portion 72a of the second handle case 72 by reason of a better visibility.

In the first to fourth embodiments, an entire surface of each of the conductive piece 14, 74, and the conductive plate 61, 81 may be continuously plated. In the first to fourth embodiments, the decorating piece 15, 62, 75, 82 may be heat-welded fixedly to the second handle case 12, 72.

In the first to fourth embodiments, a shape and a configuration of the decorating piece 15, 62, 75, 82 is an example and may be changed to meet a design of the door handle 10, 60, 70, 80. For example, the decorating piece 15, 62, 75, 82 may be configured to spread only on a front portion of the second handle case 12, 72.

In the first to fourth embodiments, the door handle 10, 60, 70, 80 may be mounted on the vehicle door in the opposite orientation to an orientation applied in the embodiments. In the first to fourth embodiments, the door handle 10, 60, 70, 80 may be fixed so as not to move relative to the outer panel 20 (the supporting member 21). In this case, a mechanism, which electrically operates the vehicle door for opening and closing in cooperation with locking/unlocking operations performed in accordance with detection results of, for example, the lock detection electrode 31, may be provided.

According to the first to fourth embodiments, the door handle apparatus adapted to be mounted on the outer panel 20 of the vehicle door, includes the first handle case 11 including the holding portion 11a defining the gap GP between the holding portion 11a and the outer surface of the outer panel 20 of the vehicle door, the second handle case 12, 72 attached to the first handle case 11 in a manner that the second handle case 12, 72 covers the first handle case 11, the conductive piece 14, 74 and the conductive plate 61, 81 provided at the outer surface of the second handle case 12, 72, the lock detection electrode 31, 71 arranged facing the conductive piece 14, 74 and the conductive plate 61, 81 and facing the inner surface of the second handle case 12, 72 for establishing the capacitive coupling between the lock detection electrode 31, 71 and the conductive piece 14, 74 and the conductive plate 61, 81, the lock detection electrode 31, 71 detecting the door-lock command on the basis of the fluctuation of the electrostatic capacity generated in response to a contact or an approach of the vehicle user relative to the conductive piece 14, 74 and the conductive plate 61, 81, and the decorating piece 15, 62, 75, 82 surrounding the conductive piece 14, 74 and the conductive plate 61, 81, joined to the outer surface of the second handle case 12, 72 and defining the design surface of the door handle apparatus.

According to the above described structure, the decorating piece 15, 62, 75, 82 is joined to the outer surface of the second handle case 12, 72. Thus, an aesthetic appearance of the second handle case 12, 72, and eventually, the aesthetic appearance of the door handle apparatus is improved. In this case, the distance between the lock detection electrode 31, 71 arranged facing the inner surface of the second handle case 12, 72 and the vehicle user increases by the thickness of the decorating piece 15, 62, 75, 82. However, the fluctuation in the electrostatic capacity of the lock detection electrode 31, 71, which is generated in response to the contact or the approach of the vehicle user to the conductive piece 14, 74 and the conductive plate 61, 81, is appropriately assured because the capacitive coupling is established between the conductive piece 14, 74, the conductive plate 61 82, which are surrounded by the decorating piece 15, 62, 75, 82, and the lock detection electrode 31, 71. Consequently, the decrease in the detection sensitivity of the lock detection electrode 31, 71 relative to the door-lock command is prevented.

According to the first and third embodiments, the conductive piece 14, 74 is arranged to penetrate through the decorating piece 15, 75 and is exposed on the surface of the decorating piece 15, 75.

According to the above described structure, the conductive piece 14, 74 penetrates through the decorating piece 15, 75 and is exposed on the surface of the decorating piece 15, 75, which allows the vehicle user to directly touch the conductive piece 14, 74. This improves the detection sensitivity, relative to the door-lock command, of the lock detection electrode 31, 71 that has the capacitive coupling between the conductive piece 14, 74. Further, the vehicle user may visually recognize the conductive piece 14, 74 exposed on the surface of the decorating piece 15, 75 and operate the door handle apparatus by, for example, touching the conductive piece 14, 74 in order to give the door-lock command. Thus, the operability of the door handle apparatus is improved.

According to the first and third embodiments, the door handle apparatus further includes a step provided between the surface of the decorating piece 15, 75 and a surface of the conductive piece 14, 74.

According to the above described structure, the step is provided between the surface of the decorating piece 15, 75 and the surface of the conductive piece 14, 74. Thus, even under poor visibility, for example, during nighttime, the vehicle user may feel the step by tracing the surface of the decorating piece 15, 75, and may operate the door handle apparatus by, for example, touching the conductive piece 14, 74 in order to give the door-lock command.

According to the second and fourth embodiments, the conductive plate 61, 81 is covered with the decorating piece 62, 82.

According to the above described structure, the conductive plate 61, 81 is not exposed on the surface of the decorating piece 62, 82, thereby further enhancing the esthetic appearance. Further, the conductive plate 61, 81 is covered with the decorating piece 62, 82 and thus it may be restricted that the lock detection electrode 31, 71 erroneously detects the door-lock command because, for example, the conductive plate 61, 81 becomes wet.

According to the second and fourth embodiments, the decorating piece 62, 82 is provided with the operational point indicating mark 62b, 82b arranged corresponding to the arrangement of the conductive plate 61, 81.

According to the above described structure, the operational point indicating mark 62b, 82b is formed at the decorating piece 62, 82 so as to correspond to the arrangement of the conductive plate 61, 81. Thus, the vehicle user may recognize the arrangement of the conductive plate 61, 81 (that is, the sensing portion of the lock detection electrode 31, 71) by identifying the operational point indicating mark 62b, 82b, and may operate the door handle apparatus by, for example, touching the decorating piece 62, 82 in order to give the door-lock command. Thus, the operability of the door handle apparatus is improved.

According to the above described structure, the door handle apparatus which improves the aesthetic appearance while avoiding the decrease in the detection sensitivity of the lock detection electrode 31, 71 is provided.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door handle apparatus adapted to be mounted on an outer panel of a vehicle door, comprising:
a first handle case including a holding portion defining a gap between the holding portion and an outer surface of the outer panel of the vehicle door;
a second handle case attached to the first handle case in a manner that the second handle case covers the first handle case;
a conductive member provided at an outer surface of the second handle case;
a lock detection electrode arranged facing the conductive member and facing an inner surface of the second handle case for establishing a capacitive coupling between the lock detection electrode and the conductive member, the lock detection electrode detecting a door-lock command on the basis of a fluctuation of an electrostatic capacity generated in response to a contact or an approach of a vehicle user relative to the conductive member; and
a decorating piece surrounding the conductive member, joined to the outer surface of the second handle case and defining a design surface of the door handle apparatus.

2. The door handle apparatus according to claim 1, wherein the conductive member is arranged to penetrate through the decorating piece and is exposed on a surface of the decorating piece.

3. The door handle apparatus according to claim 2, further comprising:
a step provided between the surface of the decorating piece and a surface of the conductive member.

4. The door handle apparatus according to claim 1, wherein the conductive member is covered with the decorating piece.

5. The door handle apparatus according to claim 4, wherein the decorating piece is provided with an operational point indicating mark arranged corresponding to an arrangement of the conductive member.
